(19) United States
(12) Patent Application Publication
(10) Pub. No.: US 2006/0218065 A1
(43) Pub. Date: Sep. 28, 2006

(54) Bundling of a utility payment with sale of a property

(75) Inventor: W. Keith Maxwell III, Houston, TX (US)

Correspondence Address: CONLEY ROSE, P.C., P. O. BOX 3267, HOUSTON, TX, 77253-3267, US

(73) Assignees: Spark Energy LP, Houston, TX (US); Utility Resource Solutions, LP, Houston, TX (US)

(21) Appl. No.: 11/243,380

(22) Filed: Oct. 4, 2005

Related U.S. Application Data
(60) Provisional application No. 60/664,958, filed on Mar. 25, 2005.

(51) Int. Cl. G06Q 40/00

(52) U.S. Cl. 705/35

(57) ABSTRACT

A method of bundling a purchase by a first party of a utility commodity provided over time by a second party with a property sold by a third party comprising: a) estimating a total cost for an amount of the utility commodity for a predetermined amount of time; b) obtaining from at least one fourth party lender, at least one loan for purchase of the property, the at least one loan providing legal tender to the first party in an amount needed to purchase the property and the amount of the utility commodity; c) conveying an amount of legal tender to the second party in amount corresponding to the total cost estimated in step a); d) conveying legal tender to the third party in an amount adequate to purchase the property; and e) delivering at least a first portion of the utility commodity to the property via a conduit.

### BACKGROUND

Purchase of a residential property, such as a house for a family home, entails numerous costs beyond the price of the home itself. Variable, and often rising, costs include bills for electricity, gas, water, property taxes, and house repairs. At various times during the year, these costs may be particularly high. A warm summer can result in an exorbitantly high electricity bill due to increased usage of air conditioning. Obviously, the spike in the electricity bill may continue for several months. Similarly, a very cold winter can result in a very high, and unexpected, increase in monthly gas or electricity bills. Whereas a given family may be able to afford the mortgage payment alone, such spikes in utility bills may cause the family to be unable to meet all of its financial obligations. Even if a spike in utility bills never occurs, the expected average cost of the utility payments may place the family's dream home beyond reach.

The invention is particularly useful in the context of a mortgage or loan for the purchase of a homestead or property. As understood by one of ordinary skill in the art, a mortgage describes a specific transaction between a lender and a lendee. A mortgage is the conditional pledge of the property to the lender as security for performance of the obligation to repay the debt used to purchase the property. A mortgage differs from a loan by virtue of the loan being secured by the property being purchased. The lender may alternately be referred to as a financier, or a person skilled in financial transactions. As understood by one of ordinary skill in the art, the loan or mortgage is typically less than the value of the property (plus utilities in the case of the invention) because most purchasers of property include a down payment with the purchase of the property. Thus, when stating that the loan or mortgage is adequate to purchase the property, it is to be understood that this is referring to the price of the property or home minus any down payment, often 20% of the purchase price of the property or home.

The reality of utility bills as a monthly cost should be considered by the purchaser before purchasing the home, even though a lender does not consider utility costs in determining whether the lendee qualifies for the mortgage. The prospect of these burdensome and volatile utility bills may cause undue stress to the family breadwinner(s) and may even put the dream of a house out of reach, particularly for families living paycheck to paycheck. This is especially true during the first few years of home ownership because home owners often purchase as much home as they can qualify for with the idea that their incomes will rise during subsequent years and in time their monthly budgets will not be as tight. A mechanism or avenue is needed that will eliminate the prospect of high, and extremely variable, utility bills during the first few years of home ownership.

### BRIEF DESCRIPTION OF THE DRAWINGS

For a better understanding of the invention, reference is made to the accompanying FIGURE, which is a flow chart of one embodiment of the invention.

### DETAILED DESCRIPTION

The preferred embodiment of the invention is a method for pre-paying for a “block” of utilities, where block refers to a specified quantity. In some embodiments, the pre-paid block can be purchased in conjuction with the purchase of a home or other property with proceeds obtained from a loan covering both the purchase price of the property and the cost of the utilities. As used herein, the term “utility,” or alternately “utility commodity,” is intended to have its ordinary meaning and includes delivery of commodities to the property such as electricity, gas, and/or water. As applied to residential customers, the pre-payment may be conveniently included in the initial purchase price for a home or combined with the purchase price of the home. Either way, the cost of the utilities is rolled into a mortgage for the home. The preferred embodiment rolls an estimated one to five years of pre-paid utility service(s) into the sales price of the home. Money, also sometimes referred to herein as currency or legal tender, sufficient to pay for the estimated cost of the utility commodity is thus delivered to the utility provider upon or shortly after the purchase of the property, for instance within 60 days after purchase or more preferably within 30 days thereafter. The actual payment for the utilities to the utility provider, as contrasted to the delivery of the mortgage or loan money to the lendee, may be delayed but this is not preferred.

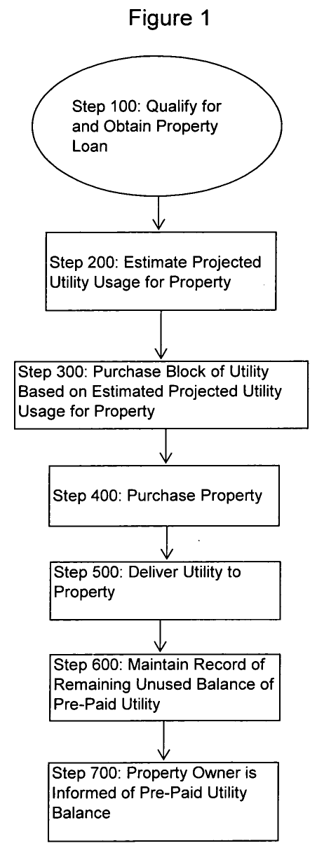

FIG. 1 illustrates one preferred embodiment of a method according to the invention. Beginning at step 100, the prospective owner of the residential or business property qualifies for and obtains a mortgage or other loan with which to purchase a property. Step 200 may be executed either before or after step 100. In step 200 an initial estimate of projected utility usage, such as electricity or water, is obtained for a specified period of time. It is believed that the typical homebuyer retains ownership of the home for only four or five years prior to selling. Thus, although not limited to a specific length of time, it may be convenient to estimate how much electricity and/or other utility service will be used over the first five years subsequent to the purchase of the property.

The details of the estimate will depend on the specific utility service(s) and are within the skill of one of ordinary skill in the art. For example, information relevant to an electricity usage estimate may include the purchaser's previous electric bills, heating type, e.g. gas or electricity, existence of central air conditioning, square footage of the residence, presence of a pool, etc. Alternately, utility usage estimates could be determined using statistical data and/or a standardized formula. If desired, these estimates can be made by a computer processor or the like, where such a computer may be found at any suitable location including with the utility provider.

At step 300, a block of electricity or other utility equal to the estimate resulting from step 200 is purchased from the utility supplier. The cost of this utility block may be included in the loan or mortgage amount and is payable to the provider of the utility commodity or to the entity that delivers the utility commodity.

Purchase of a utility commodity may be from any suitable provider of a given utility. One suitable provider of electricity is Spark Energy, LP. The purchaser of the property may independently contract with the utility provider to obtain a block of a utility commodity. Alternatively a third party, such as the seller of the property, may coordinate with the utility provider so that the purchase of the utility may be made by the prospective purchaser of the property through this third party. Regardless of whether a third party is involved with the purchase, part of the loan proceeds obtained in step 100 are then used to pay for the block of utility, as indicated by step 300. This step may but does not necessarily coincide with the purchase of the property, which may be a residential structure, e.g. house, townhouse, condominium, or the like, indicated by step 400. Payment for the property is also made using loan proceeds obtained at step 1100. The size of the mortgage or other loan may vary depending on the lender or other variables. This calculation is within the skill of one of ordinary skill in the art.

The method described herein has particular applicability when combined with the purchase of a home. In fact, there are numerous advantages to bundling a purchase of a property with a pre-paid purchase of a utility. Bundling of what is expected to be several years of a utility, or even better, multiple utilities, with the home loan provides two major advantages: (1) the monthly payment for the home and utility or utilities will be a known constant from month-to-month, allowing a family to budget each month and (2) the payment for the purchased utilities is spread out over the life of the mortgage. The second advantage allows a family moving into a home to pay for all the utilities it will use during the first five years subsequent to purchase of the home over the life of the loan or mortgage, typically 30 years. Spreading these utility costs over the life of the mortgage can drastically reduce utility payments made during those first five years of home ownership. This method provides yet another advantage in that a customer may eliminate separate monthly utility and mortgage payments. The resultant effect of the advantages gained by bundling the cost of utilities into or with the purchase price of a home may bring what is loosely referred to as “the American dream” in reach for many families who may not otherwise be able to purchase a home.

Although these advantages represent a significant incentive for a home owner, or purchaser of other property, there are other benefits to bundling one or more utilities with the purchase of property. One such benefit is the ability to lock in a set rate for the entire block of purchased utility. By locking in a utility rate, the homeowner is protected from either short-term or long-term rises in the utility rate because the risk of rate increases is shifted to the utility provider. Given that utility rates generally rise, this may ultimately prove to be a major advantage to the buyer of a home or other property. Of course, a premium may be charged by the utility provider in order to protect against this risk, but the homeowner nonetheless has the assurance that his utility cost will not rise. Alternately, the utility provider may assure the homeowner who purchases a block of a utility commodity that the cost of that commodity will increase by only a maximum amount.

One aspect of the invention deserves special emphasis because it is so advantageous to a family purchasing property, often a starter home symbolizing the “American dream.” Where a mortgage loan is used to buy the house, as is typical, the cost for the block of utility will be spread over the full duration of the mortgage, often 30 years. This will significantly decrease the monthly utility payments during the period of time for which the utilities have been pre-paid. This reduction in monthly utility payments and the stability provided by a known, constant payment encompassing both the cost of the home and pre-paid utilities are very significant advantages, particularly for a couple just beginning careers. Given that the typical homeowner sells his or her home less than four to five years after purchase, the mortgage loan, and hence the one-time utility payment, will be paid off prior to the full duration of the mortgage, assuming the mortgage is paid upon sale of the property. Even where the utility customer, such as a family, does not move, the substantially reduced monthly utility payment eases the burden on the family during the period of time for which the utilities are pre-paid as the family's income increases over the first few years of occupancy, as is typical. In other words, the bundling of one or more utility payment for a number of years with a mortgage loan, as expressed above and according to the invention, is ideal for the family eager to purchase a “starter home.”

Step 400 is the legal purchase of the real estate, including legal necessities such as title insurance. Generally coinciding with the purchase of the real estate is the up-front payment for the block of electricity, gas and/or other utility service indicated by step 300. It is believed this would most conveniently be a single payment made with part of the proceeds of the mortgage.

At some point, typically following step 400, the utility provider begins delivery of the purchased utility, such as electricity or water, to the structure on the property. In most cases, the amount of the utility delivered will correspond to the amount demanded by residents of the home or property. Thus, step 500 comprises the delivery of the utility to the property over a suitable conduit. Step 500 may be carried out in increments over an amount of time that may be either predetermined or determined by the rate of consumption of the pre-purchased block of utility(ies). In any case, the utilities are delivered via conventional means. Electricity may be delivered over wires, for example, and water and gas may be delivered through a suitable number of pipelines.

Step 600 addresses record-keeping regarding of the remaining balance of unused, pre-paid utility commodities. Each month, the monetary charge for actual utility usage, including any non-recurring charges, is determined in accordance with principles known by those of ordinary skill in the art and the resulting amount is charged against the quantity purchased, a practice known as “setting off.” More specifically, the amount of utility used is subtracted, or “set off,” from the un-used, pre-paid amount. Preferably, the monetary value of utility usage set off against the pre-paid block is the predetermined utility rate multiplied by the quantity of utility used by the property owner over the given time frame, for example the month. This calculation may be accomplished with a computer or computer processor at any suitable location. One such suitable location is at the utility provider. Subsequently, the property owner is preferably informed of the remaining balance for the pre-paid utility, as indicated by optional step 700. For example, assuming a pre-paid block of electricity, a monthly statement can be sent to the property owner showing the kilowatt hours (kWh) used during the billing period and the total remaining pre-paid kWh balance.

One of ordinary skill in the art can appreciate that a computer or computer processor may be used for calculations used in the inventive steps described above.

While the sale of a pre-purchased block of utilities is particularly advantageous when carried out in conjunction with a sale of real property as described above, it will be understood that it may also be carried out independently from such a sale. For example, sale of a pre-purchased block of utilities could be carried out in conjunction with initiation of a least, or in conjunction with a renovation or remodeling. Likewise, while it is advantageous and preferred to carry out a sale of a pre-purchased block of utilities at a time when the total cost of the block can be added to the principal of a new loan, the invention is not limited to such timing. For example, according to the invention, a utility vendor may sell a pre-paid block of utilities to a purchaser for the purpose of reducing both the vendor's and the purchaser's risk with regard to changes in energy costs.

The present invention is not limited to the embodiments described above. While preferred embodiments of this invention have been shown and described, modifications thereof can be made by one skilled in the art without departing from the scope or teaching of this invention. Accordingly, the invention is not limited to the embodiments described herein, but is only limited by the claims that follow, the scope of which shall include all equivalents of the subject matter of the claims. Likewise, the sequential recitation of steps in a claim, unless explicitly so stated, is not intended to require that the steps be performed in any particular order or that a particular step be completed before commencement of another step.

What is claimed is:

1. A method of bundling a purchase by a first party of a desired amount of a utility commodity provided over time by a second party with a purchase of a property sold by a third party, comprising:
a) establishing a total cost for the desired amount of said utility commodity;
b) adding the total cost established in step a) to the price of the property; and
c) upon purchase of the property conveying an amount of legal tender to said second party in amount corresponding to said total cost established in step a).

2. The method of claim 1 wherein the desired amount of the utility is based upon one year's expected usage.

3. The method of claim 1 wherein the desired amount of the utility is based upon five years' expected usage.

4. A method of bundling a purchase by a first party of a desired amount of a utility commodity provided over time by a second party with a purchase of a property sold by a third party comprising:
a) establishing a total cost for the desired amount of said utility commodity;
b) obtaining from at least one fourth party lender, at least one loan for the purchase of said property, said at least one loan providing legal tender to said first party in an amount sufficient to purchase said property and said amount of said utility commodity;
c) conveying an amount of legal tender to said second party in amount corresponding to said total cost established in step a);
d) conveying legal tender to said third party in an amount adequate to purchase said property; and
e) delivering at least a first portion of said utility commodity to said property via a conduit.

5. The method of claim 4, further comprising:
calculating the cost of said first portion prior to said step of transferring, said step c), said calculating step being executed by a computer processor; and
deducting said cost for said first portion of said utility commodity from said total cost.

6. The method of claim 5 wherein said deducting step yields a remaining value for said utility commodity owed to said first party, wherein said method further comprises sending to said first party a statement of said remaining value.

7. The method of claim 4 wherein the transfer of said amount of legal tender to said second party is the sole transfer to said second party for said cost of said utility commodity.

8. The method of claim 4 wherein said loan is secured by said property.

9. The method of claim 4 wherein said predetermined amount of time is five years.

10. The method of claim 4 wherein said utility commodity is electricity.

11. The method of claim 4 wherein said utility commodity is water.

12. The method of claim 4 wherein said utility commodity is gas.

13. The method of claim 4 wherein said utility commodity includes a first utility commodity and a second utility commodity, said second utility commodity being estimated and included in said loan amount.

14. The method of claim 4 wherein said step of estimating is based on prior usage of said utility commodity by said first party.

15. A method of bundling a purchase by a first party of a desired amount of a utility commodity provided over time by a second party with the acquisition of a loan by said first party, comprising:
a) establishing a total cost for the desired amount of said utility commodity;
b) adding the total cost established in step a) to the amount of the loan; and
c) upon acquisition of the loan conveying an amount of legal tender to said second party in amount corresponding to said total cost established in step a).

16. The method of claim 15 wherein the desired amount of the utility is based upon one year's expected usage.

18. The method of claim 15 wherein the desired amount of the utility is based upon five years' expected usage.
